(19) United States
(12) Patent Application Publication
(10) Pub. No.: US 2007/0275721 A1
(43) Pub. Date: Nov. 29, 2007

(54) Method of Providing a Hard Handoff Between Mscs During an Alerting State

(76) Inventor: Myeong Seon Seo, Seoul (KR)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/556,769

(22) PCT Filed: May 28, 2004
(86) PCT No.: PCT/KR04/01268

§ 371 Date: Feb. 14, 2007

(30) Foreign Application Priority Data
May 30, 2003 (KR) 10-2003-0034802

(51) Int. Cl. H04Q 7/20

(52) U.S. Cl. 455/436; 455/435.2

(57) ABSTRACT

A method of providing a hard handoff between Mobile Switching Centers (MSCs) during an alerting state. A Base Station Controller (BSC) requests a handoff to an MSC in case a Mobile Station (MS) transmits a Pilot Strength Measurement Message (PSMM) during an alerting state and a condition for a hard handoff between MSCs is satisfied. Otherwise, if a hard handoff request message is transmitted from the MSC, a conventional handoff operation is performed in a target BSC. After the alerting state, a connection order from the MS or a connection message from the MSC is processed. Therefore, the possibility that the hard handoff will succeed increases and the mobility of the MS is ensured.

### TECHNICAL FIELD

The present invention generally relates to a method of providing a hard handoff between Mobile Switching Centers (MSCs) during an alerting state. In particular, a Base Station Controller (BSC) requests a handoff to an MSC in case a Mobile Station (MS) transmits a Pilot Strength Measurement Message (PSMM) during an alerting state and a condition for a hard handoff between MSCs is satisfied. Otherwise, if a hard handoff request message is transmitted from the MSC, a conventional handoff operation is performed in a target BSC. After the alerting state, a connection order from the MS or a connection message from the MSC is processed. Therefore, the possibility that the hard handoff will succeed increases and the mobility of the MS is ensured.

### BACKGROUND ART

In general, a hard handoff is performed within an area where different types of mobile communication systems, which are geographically adjacent, provide services. A hard handoff has a higher chance of causing a call disconnection than a soft handoff resulting in degradation of communication quality.

In a conventional second generation (2G) Code Division Multiple Access (CDMA) system, a hard handoff between MSCs is allowed only when an MS is engaged in a call. Where a call is an incoming or outgoing, a hard handoff between MSCs would not be allowed until the MS is engaged in the call.

Therefore, when an MS attempts a call while moving, a call disconnection will occur at the site where only a hard handoff between MSCs is allowed. At such site, if an alerting state is extended, the possibility of call disconnection at an originating or destination MS will be increased.

### DISCLOSURE OF THE INVENTION

It is, therefore, an objective of the present invention to provide a method of providing a hard handoff between Mobile Switching Centers (MSCs) during an alerting state.

In accordance with the present invention, there is provided a method of providing a handoff between a Mobile Switching Center (MSC) in a serving system and an MSC in a target system during an alerting state in a mobile communication system, comprising the steps of: transmitting, at a Mobile Station (MS), a Pilot Strength Measurement Message (PSMM) during an alerting state, requesting a handoff to the MSC in the serving system if a condition for a hard handoff between the MSCs is satisfied; and performing a conventional handoff operation at a Base Station Controller (BSC) in the target system when a hard handoff request message is transmitted from the MSC in the serving system; and, after the alerting state, processing a connection order from the MS or a connection message from the MSC in the serving system.

Also, in accordance with the present invention, there is provided a method of providing a handoff between a Mobile Switching Center (MSC) in a serving system and an MSC in a target system during an alerting state in a mobile communication system, further comprising: determining, at a BSC in the serving system, the condition and a type of hard handoff if the MS transmits the PSMM; transmitting, at the BSC in the serving system, a handoff required message to the MSC in the serving system after determining the handoff type; and receiving, at the MSC in the serving system, the handoff required message and requesting the handoff to the target system if a handoff available timing is satisfied.

The foregoing and other objects and features of the present invention will become more fully apparent from the following description and appended claims, taken in conjunction with the accompanying drawings.

### BRIEF DESCRIPTION OF DRAWINGS

It should be understood that these drawings depict only the preferred embodiments of the invention and are, therefore, not to be considered as limitations of its scope. The invention will be described with additional specificity and detail through the use of the accompanying drawings in which:

FIG. 1 shows a block diagram of a system for providing a hard handoff between Mobile Switching Centers (MSCs) in accordance with the present invention.

FIG. 2 shows a diagram of providing a hard handoff between MSCs in accordance with the present invention.

FIG. 3 shows a diagram of a procedure for an originating call and a hard handoff timing between MSCs.

FIG. 4 shows a diagram of explaining a procedure for an incoming call and a hard handoff timing between MSCs.

### BEST MODE FOR CARRYING OUT THE INVENTION

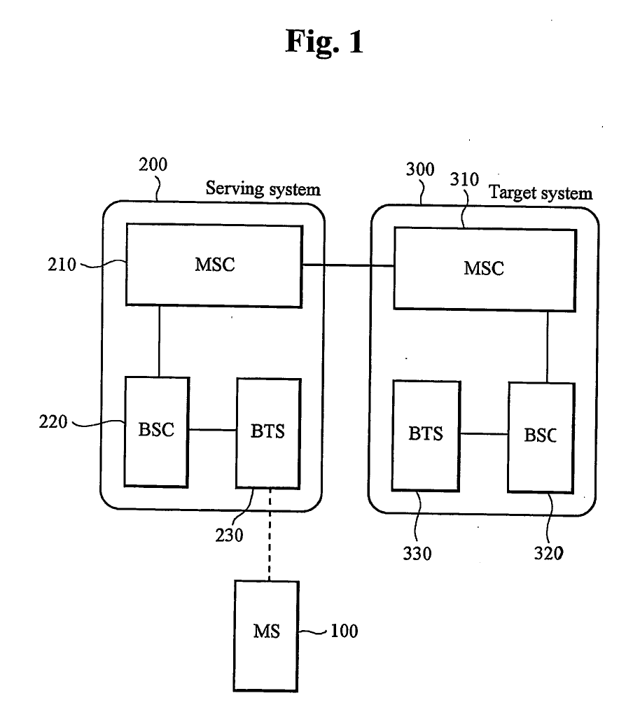

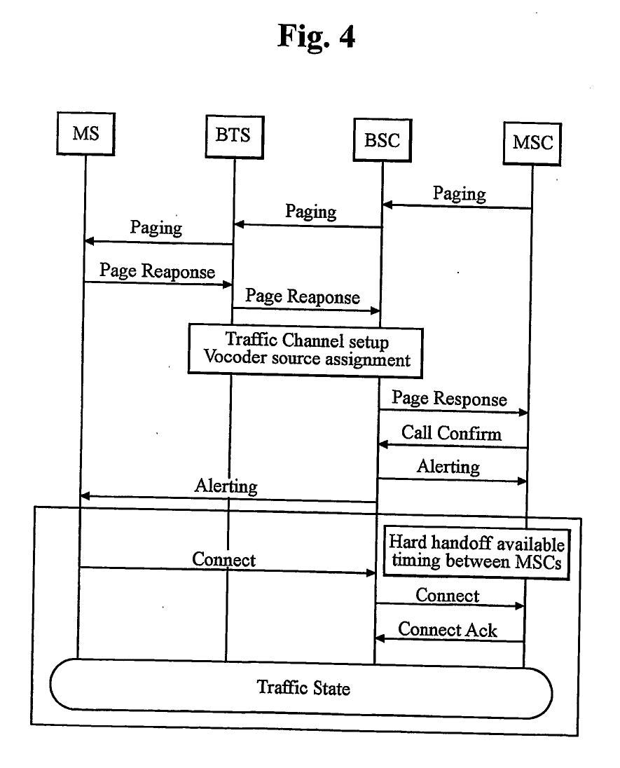

It will be readily understood that the components and steps of the present invention, as generally described and illustrated herein and in the accompanying Figures, may be arranged and designed in a wide variety of different configurations while still utilizing the inventive concept of the present invention. Thus, the detailed description of the preferred embodiments of the present invention, as described and illustrated herein and in FIGS. 1 and 4, is not intended to limit the scope of the present invention. It is merely representative of the preferred embodiments of the present invention. The preferred embodiments of the present invention will be best understood by reference to FIGS. 1 and 4, wherein certain parts or steps described herein are designated by their corresponding numerals throughout the Figures.

Referring to FIG. 1, there is shown a block diagram of a system for providing a hard handoff between Mobile Switching Centers (MSCs) in accordance with the present invention. As shown in FIG. 1, the system comprises Mobile Station (MS) 100, first mobile communication system 200, and second mobile communication system 300. First mobile communication system 200 (hereinafter, referred to as serving system 200) includes Mobile Switching Center (MSC) 210, Base Station Controller (BSC) 220, and Base station Transceiver Subsystem (BTS) 230. Second mobile communication system 300 (hereinafter, referred to as target system 300) includes MSC 310, BSC 320, and BTS 330.

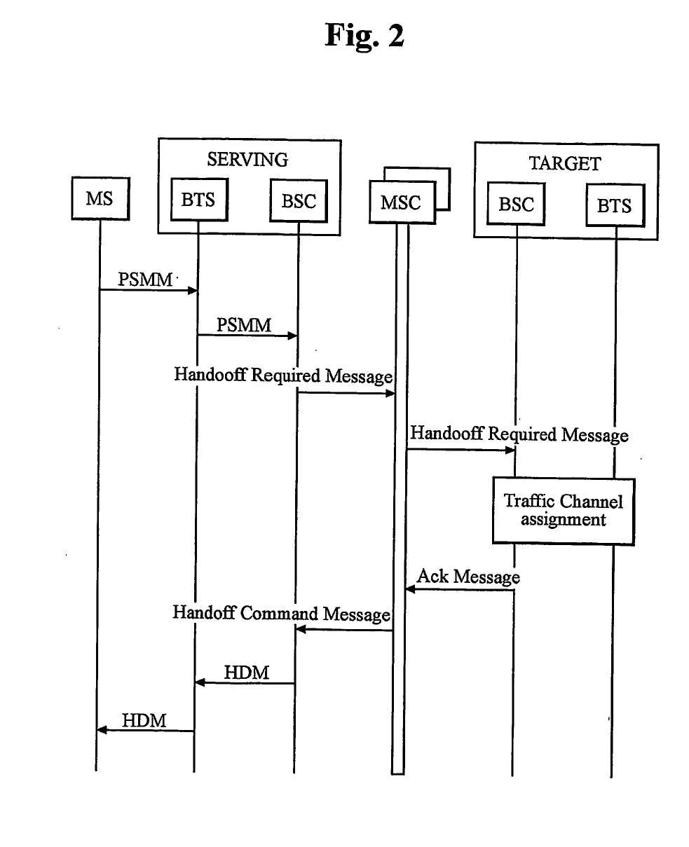

Referring to FIG. 2, there is shown a diagram of providing a hard handoff between MSCs 210 and 310 in accordance with the present invention. A physical channel is not established between BSCs 220 and 320. It is assumed that BTS 230 is installed in proximity to BTS 330. Here, MS 100, which requested a call to BTS 230, is moved to BTS 330. If a pilot strength of BTS 230 is weaker than that of BTS 330, a handoff will occur.

As shown in FIG. 2, MS 100 transmits a Pilot Strength Measurement Message (PSMM) to BTS 230. Then, BCS 220 determines a condition and a type of a handoff. At this time, since a physical channel is not established between BSCs 220 and 320, BCS 220 determines the type of handoff as a hard handoff between MSCs 210 and 310.

After determining the handoff type, BCS 220 transmits to MSC 210 a handoff required message for requesting a hard handoff between MSCs 210 and 310.

MSC 210 receives the handoff required message and then requests a handoff to target system 300 if it is time to handoff, i.e., after an alerting state. In the mobile communication system, a status of an MS is classified into a null state, an initial state, a traffic setup state, an alerting state, a connect state, and a traffic state.

Subsequent procedure after requesting a handoff is well known in the art. For simplicity, detailed description for the subsequent procedure will be omitted herein.

According to the prior art, a handoff timing between MSCs 210 and 310 starts in a traffic state. However, in accordance with the present invention, the handoff timing starts at an alerting state. That is, it advances the process timing for a handoff request message received from MSC 310 at BCS 320 in target system 300, and for a handoff required message transmitted to MSC 210 in serving system 200.

In case the handoff timing between MSCs 210 and 310 is advanced as described above, BSC 320 in target system 300 has to manage and process a handed-off call from the alerting state.

According to the prior art, if MS 100 is moved to target system 300 while in a traffic state, BSC 320 manages a status of a call originated from MS 100 as a traffic state after completing a handoff process. Otherwise, if MS 100 is moved to target system 300 before a call connection is established, BSC 320 processes a connect order from MS 100 to establish a call connection for MS 100.

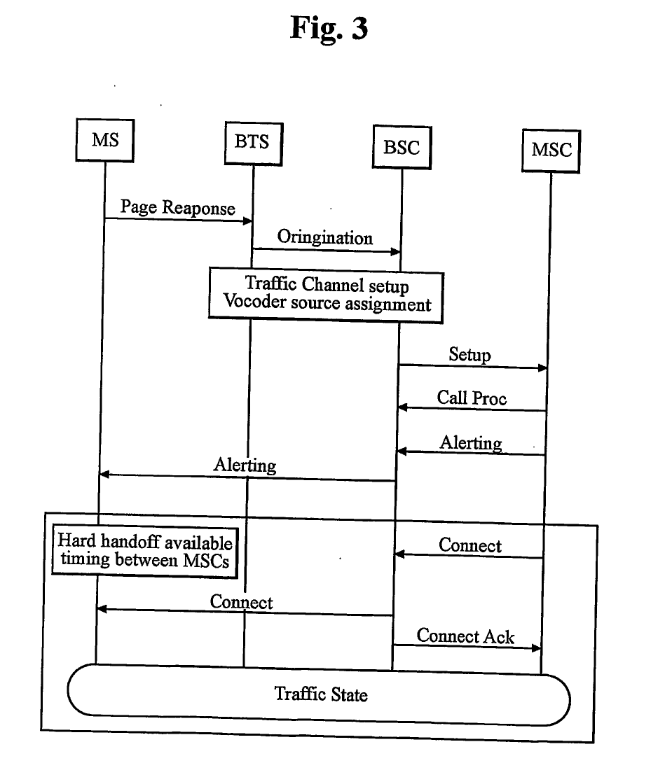

Referring to FIG. 3, there is shown a diagram of explaining a procedure for an originating call and a hard handoff timing between MSCs 210 and 310. MS 100 originates a call to BTS 230. BTS 230 then transmits the originating call to BSC 220. At this time, a traffic channel setup and a vocoder resource assignment are processed between BTS 230 and BSC 220.

BSC 220 requests a call setup for the originating call to MSC 210. MSC 210 transmits a response for the request and an alerting message to BSC 220.

After receiving the response from MSC 210, BSC 220 transmits the alerting message to MS 100 through BTS 230. At this point, a handoff between MSCs 210 and 310 is available.

After BSC 220 transmits the alerting message to MS 100, MSC 210 transmits a call connection to BSC 220. BSC 220 then transmits the call connection to MS 100 through BTS 230 and a response for the call connection to MSC 210. After transmitting the response, a traffic state is maintained.

Referring to FIG. 4, there is shown a diagram of explaining a procedure for an incoming call and a hard handoff timing between MSCs 210 and 310. As shown in FIG. 4, MSC 210 requests a paging to BSC 220. Then, BSC 220 transmits a paging message to BTS 230. After receiving, BTS 230 transmits the paging message to MS 100.

MS 100 receives the paging message and transmits a page response to BTS 230. BTS 230 transmits the page response to BSC 220. At this time, a traffic channel setup and a vocoder resource assignment are processed between BTS 230 and BSC 220.

BSC 220 transmits the page response received from BTS 230 to MSC 210. Then, MSC 210 transmits a call confirm message to BSC 220.

After receiving the call confirm message from MSC 210, BSC transmits an alerting message to MSC 210 and to MS 100 through BTS 230. Thereafter, MS 100 requests a call connection to BSC 220 through BTS 230. At this point, a handoff between MSCs 210 and 310 is available. BSC 220 transmits the call connection request to MSC 210. MSC 210 then transmits a response for the call connection request to BSC 220. After transmitting the response from MSC 210 to BSC 220, a traffic state is maintained. E

### INDUSTRIAL APPLICABILITY

As described above, in accordance with the present invention, a Base Station Controller (BSC) requests a handoff to an MSC in case a Mobile Station (MS) transmits a Pilot Strength Measurement Message during an alerting state and a condition for a hard handoff between MSCs is satisfied. Otherwise, if a hard handoff request message is transmitted from the MSC, a conventional handoff operation is performed in a target BSC. After the alerting state, a connection order from the MS or a connection message from the MSC is processed. Therefore, the possibility that the hard handoff will succeed increases and the mobility of the MS is ensured.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the spirit and scope of the invention.

1. A method of providing a handoff between a Mobile Switching Center (MSC) in a serving system and an MSC in a target system during an alerting state in a mobile communication system, comprising the steps of:
transmitting, at a Mobile Station (MS), a Pilot Strength Measurement Message (PSMM) during an alerting state, thereby requesting a handoff to the MSC in the serving system if a condition for a hard handoff between the MSCs is satisfied; and
performing a conventional handoff operation at a Base Station Controller (BSC) in the target system when a hard handoff request message is transmitted from the MSC in the serving system, and, after the alerting state, processing a connection order from the MS or a connection message from the MSC in the serving system.

2. The method of claim 1, wherein further comprising:
determining, at a BSC in the serving system, a condition and type of hard handoff if the MS transmits the PSMM;
transmitting, at the BSC in the serving system, a handoff required message to the MSC in the serving system after determining the handoff type; and
receiving, at the MSC in the serving system, the handoff required message and requesting handoff to the target system if a handoff available timing is satisfied.

3. The method of claim 1 or 2, wherein the handoff type is determined, at the BSC in the serving system, as a hard handoff between the MSCs if a physical channel is not established between the BSCs.

4. The method of claim 1 or 2, wherein the BSC in the target system manages and processes a handed-off call from the alerting state.
